(19) United States
(12) Patent Application Publication
(10) Pub. No.: US 2025/0343280 A1
(43) Pub. Date: Nov. 6, 2025

(54) ELECTROLYTES FOR RECHARGEABLE LITHIUM BATTERIES AND RECHARGEABLE LITHIUM BATTERIES INCLUDING THE SAME

(71) Applicant: Samsung SDI Co., Ltd., Yongin-si (KR)

(72) Inventors: Sangwoo PARK, Yongin-si (KR); Sanghoon KIM, Yongin-si (KR); Hyunbong CHOI, Yongin-si (KR); Sohee KIM, Yongin-si (KR); Yeji YANG, Yongin-si (KR); Hongryeol PARK, Yongin-si (KR); Dasol JUN, Yongin-si (KR)

(21) Appl. No.: 18/952,872

(22) Filed: Nov. 19, 2024

(30) Foreign Application Priority Data
May 3, 2024 (KR) 10-2024-0059307

(51) Int. Cl. H01M 10/42; H01M 4/58; H01M 4/587; H01M 10/052; H01M 10/0567; H01M 10/0569

(52) U.S. Cl. CPC H01M 10/4235; H01M 4/5825; H01M 4/587; H01M 10/052; H01M 10/0567; H01M 10/0569; H01M 2300/004

(57) ABSTRACT

An electrolyte for a rechargeable lithium battery and a rechargeable lithium battery including the electrolyte are disclosed. The electrolyte for a rechargeable lithium battery may include a non-aqueous organic solvent, a lithium salt, a first additive represented by Chemical Formula 1, and a second additive represented by Chemical Formula 1:

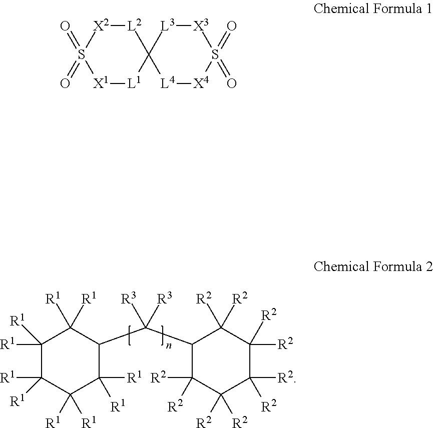

### CROSS-REFERENCE TO RELATED APPLICATION

The present application claims priority to and the benefit of Korean Patent Application No. 10-2024-0059307, filed on May 3, 2024, in the Korean Intellectual Property Office, the entire disclosure of which is incorporated herein by reference.

### BACKGROUND

### 1. Field

One or more embodiments of the present disclosure relate to an electrolyte for a rechargeable lithium battery and a rechargeable lithium battery including the electrolyte.

### 2. Description of the Related Art

A rechargeable lithium battery may be recharged and have three or more times as high energy density per unit weight as a lead storage battery, a nickel-cadmium battery, a nickel hydrogen battery, a nickel zinc battery, and/or the like. It may also be charged at a high rate and thus, may be commercially manufactured for a laptop, a cell phone, an electric tool, an electric bike, and/or the like. Research on improvement or enhancement of additional energy density has been actively made.

Such a rechargeable lithium battery may be manufactured by injecting an electrolyte into an electrode assembly which includes a positive electrode including a positive electrode active material that is capable of intercalating/deintercalating lithium ions and a negative electrode including a negative electrode active material that is capable of intercalating/deintercalating lithium ions.

If (e.g., when) such a rechargeable lithium battery is continuously (or repeatedly) charged and discharged and/or stored at a high temperature, hydrogen fluoride (HF), an undesirable high-temperature positive electrode decomposition product of a lithium hexafluorophosphate (LiPF₆) salt, may react with the positive electrode active material to elute transition metal (e.g., iron (Fe)) ions from the active material. The transition metal ions eluted from the positive electrode active material move through the electrolyte and then may be precipitated as transition metals on the negative electrode surface. The electrolyte may be continuously decomposed on the surface of the precipitated portion to generate gas and/or increase resistance (e.g., electrical resistance), which may accelerate deterioration of the rechargeable lithium battery. Moisture (e.g., H₂O) present inside the battery may accelerate the decomposition reaction of a LiPF₆ salt at a high temperature and thereby, increase the generation of HF, an acidic material, which may further accelerate the deterioration reaction.

### SUMMARY

One or more aspects of embodiments of the present disclosure are directed toward an electrolyte for a rechargeable lithium battery that may reduce the elution of transition metals from the active material (or reduce a degree or occurrence of the elution of transition metals from the active material) by removing or reducing moisture (e.g., H₂O) in the rechargeable lithium battery, suppress or reduce salt decomposition and/or generation of acidic substances at high temperatures (or suppress or reduce a degree or occurrence of salt decomposition and/or generation of acidic substances at high temperatures), and/or improve or enhance charge/discharge and/or high-temperature storage characteristics of the rechargeable lithium battery.

One or more aspects of embodiments of the present disclosure are directed toward a rechargeable lithium battery including the electrolyte for a rechargeable lithium battery.

Additional aspects of embodiments will be set forth in part in the description which follows and, in part, will be apparent from the description, or may be learned by practice of the presented embodiments of the disclosure.

The electrolyte for a rechargeable lithium battery may include a non-aqueous (e.g., water-insoluble) organic solvent; a lithium salt (e.g., LiPF₆); and an additive, wherein the additive may include a first additive represented by Chemical Formula 1 and a second additive represented by Chemical Formula 2:

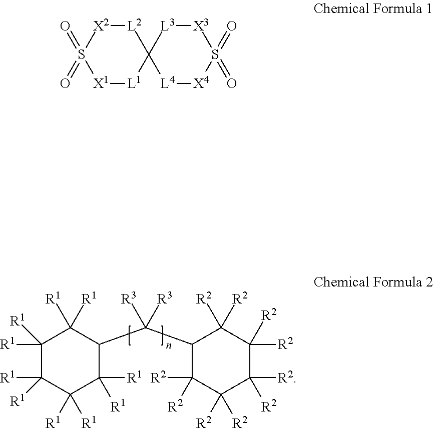

The rechargeable lithium battery may include a positive electrode including a positive electrode active material, a negative electrode including a negative electrode active material, and an electrolyte.

The electrolyte for a rechargeable lithium battery according to one or more embodiments may reduce the elution of transition metals from the active material (or reduce a degree or occurrence of the elution of transition metals from the active material) by removing or reducing moisture (e.g., H₂O) in the rechargeable lithium battery, suppress or reduce salt decomposition and/or generation of acidic substances at high temperatures (or suppress or reduce a degree or occurrence of salt decomposition and/or generation of acidic substances at high temperatures), and/or improve or enhance charge/discharge and/or high-temperature storage characteristics of the rechargeable lithium battery.

### BRIEF DESCRIPTION OF THE DRAWINGS

The above and other aspects and features of certain embodiments of the present disclosure will be more apparent from the following description taken in conjunction with the accompanying drawings, in which:

FIGS. 1-4 each is a schematic view illustrating rechargeable lithium batteries according to one or more embodiments.

### DETAILED DESCRIPTION

Hereinafter, embodiments will be described in more detail. However, these embodiments are examples, the present disclosure is not limited thereto and the present disclosure is defined by the scope of the appended claims and equivalents thereof.

As utilized herein, the singular forms “a,” “an,” and “the” are intended to include the plural forms as well, unless the context clearly indicates otherwise. Further, the utilization of “may” when describing embodiments of the present disclosure refers to “one or more embodiments of the present disclosure.”

In the context of the present disclosure and unless otherwise defined, the terms “use,” “using,” and “used” may be considered synonymous with the terms “utilize,” “utilizing,” and “utilized,” respectively.

As utilized herein, the term “about” or similar terms are used as terms of approximation and not as terms of degree, and are intended to account for the inherent deviations in measured or calculated values that would be recognized by those of ordinary skill in the art. “About” or “approximately,” as used herein, is also inclusive of the stated value and refers to within an acceptable range of deviation for the particular value as determined by one of ordinary skill in the art, considering the measurement in question and the error associated with measurement of the particular quantity (e.g., the limitations of the measurement system). For example, “about” may refer to within one or more standard deviations or within ±30%, 20%, 10%, or ±5% of the stated value.

Any numerical range recited herein is intended to include all sub-ranges of substantially the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend the present disclosure, including the appended claims, to expressly recite any sub-range subsumed within the ranges expressly recited herein.

As used herein, if (e.g., when) specific definition is not otherwise provided, it will be understood that if (e.g., when) an element, such as a layer, a film, region, or a substrate, is referred to as being “on” another element, it may be directly on the other element or intervening elements may also be present. If (e.g., when) an element is referred to as being “directly on” another element, there may be no intervening elements present.

As used herein, if (e.g., when) specific definition is not otherwise provided, the singular may also include the plural. In one or more embodiments, unless otherwise specified, “A or B” may refer to “including A, including B, or including A and B.”

As used herein, “combination thereof” may refer to a mixture of constituents, a stack, a composite, a copolymer, an alloy, a blend, and/or a reaction product.

As used herein, if (e.g., when) specific definition is not otherwise provided, “substituted” refers to replacement of at least one hydrogen atom of a compound by a substituent selected from among a halogen atom (F, Cl, Br, or I), a hydroxyl group, a C1 to C20 alkoxy group, a nitro group, a cyano group, an amine group, an imino group, an azido group, an amidino group, a hydrazino group, a hydrazono group, a carbonyl group, a carbamyl group, a thiol group, an ester group, an ether group, a carboxyl group or a salt thereof, a sulfonic acid group or a salt thereof, a phosphoric acid or a salt thereof, a C1 to C20 alkyl group, a C2 to C20 alkenyl group, a C2 to C20 alkynyl group, a C6 to C30 aryl group, a C3 to C20 cycloalkyl group, a C3 to C20 cycloalkenyl group, a C3 to C20 cycloalkynyl group, a C2 to C20 heterocycloalkyl group, a C2 to C20 heterocycloalkenyl group, a C2 to C20 heterocycloalkynyl group, or a combination thereof.

As used herein, if (e.g., when) specific definition is not otherwise provided, “heterocycloalkyl group,” “heterocycloalkenyl group,” “heterocycloalkynyl group,” and “heterocycloalkylene group” refer to that at least one heteroatom selected from among nitrogen (N), oxygen (O), sulfur (S) or phosphorus (P) is present in the ring compound of cycloalkyl, cycloalkenyl, cycloalkynyl, and cycloalkylene, respectively.

In chemical formulas of the present disclosure, unless a specific definition is otherwise provided, a hydrogen atom (H) is bonded at the position if (e.g., when) a chemical bond is not drawn where supposed to be given.

### Electrolyte

One or more embodiments of the present disclosure provide an electrolyte for a rechargeable lithium battery that may include a non-aqueous (e.g., water-insoluble) organic solvent; a lithium salt; and an additive, wherein the additive may include a first additive represented by Chemical Formula 1; and a second additive represented by Chemical Formula 2:

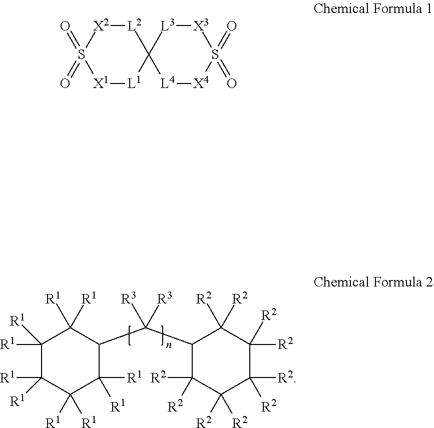

The first additive represented by Chemical Formula 1 may be an alkane sultone-based compound, which may decompose on the electrode surface and may have the effect of forming a robust film of sulfite (—SO₃)-based component that is stable at high temperature and/or has high heat resistance.

In one or more embodiments, the second additive represented by Chemical Formula 2 may have a chemical structure in which two cyclohexyl-based compounds substituted with an isocyanate group may be linked through a linker (*—(C(R³))—*), and two isocyanate groups in one molecule may effectively or suitably remove moisture (e.g., H₂O).

In one or more embodiments, the electrolyte for a rechargeable lithium battery according to one or more embodiments may include the above two types or kinds of additives, thereby removing or reducing moisture (e.g., H₂O) (or removing or reducing a degree or occurrence of moisture (e.g., H₂O)) in the rechargeable lithium battery, suppressing or reducing the elution of transition metals from the positive electrode active material and/or accompanying side reactions (or suppressing or reducing a degree or occurrence of the elution of transition metals from the positive electrode active material and/or accompanying side reactions), and/or improving or enhancing the charging/discharging and/or high-temperature storage characteristics of rechargeable lithium batteries.

Hereinafter, the electrolyte according to one or more embodiments will be described in more detail.

### First Additive

A description of Chemical Formula 1 representing the first additive is as follows.

X¹ to X⁴ may each independently be a single bond (e.g., a single covalent bond), an oxygen atom (O), or a sulfur atom (S).

For example, one selected from among X¹ and X² may be O, and one selected from among X³ and X⁴ may be O.

L¹ to L⁴ may each independently be a single bond (e.g., a single covalent bond), a carbonyl group, a sulfinyl group, or a substituted or unsubstituted C1 to C10 alkylene group.

For example, L¹ to L⁴ may each independently be a substituted or unsubstituted C1 to C5 alkylene group.

Chemical Formula 1 may be represented by Chemical Formula 1-1 or 1-2:

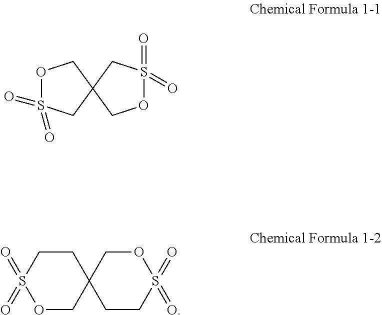 [SMILES: O=S1(=O)CC2(CO1)COS(=O)(=O)C2 ; O=S1(=O)CCC2(CCS(=O)(=O)OC2)CO1]

### Second Additive

A description of Chemical Formula 2 representing the second additive is as follows.

R¹ may be the same or different and may each independently be a hydrogen atom, a halogen atom, an alkyl group having 1 to 10 carbon atoms, or an isocyanate group; provided that at least one selected from among R¹s is an isocyanate group.

For example, at least one selected from among R¹s may be an isocyanate group; except for this, R¹s may be the same or different, and may each independently be a hydrogen atom, a halogen atom, or an alkyl group having 1 to 10 carbon atoms.

For example, all of R¹s except the isocyanate group may be hydrogen atoms.

R² may be the same or different and may each independently be a hydrogen atom, a halogen atom, or an alkyl group having 1 to 10 carbon atoms, or an isocyanate group; provided that at least one selected from among R²s is an isocyanate group.

For example, at least one selected from among R²s may be an isocyanate group; except for this, R² may be the same or different, and may each independently be a hydrogen atom, a halogen atom, or an alkyl group having 1 to 10 carbon atoms.

For example, all of R²s except the isocyanate group may be hydrogen atoms.

R³ may be the same or different and may each independently be a hydrogen atom or a cyclohexyl isocyanate moiety (or a cyclohexyl isocyanate residue).

For example, R³ may be a hydrogen atom.

n may be an integer of 1 to 10.

For example, n may be 1.

Chemical Formula 2 may be represented by Chemical Formula 2-1, and the definitions for each substituent are as follows:

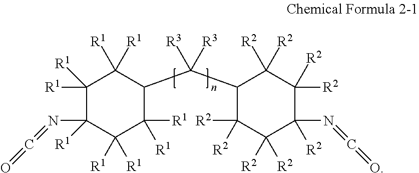

Content (or amount)/Mixing Ratio of First Additive and Second Additive

The first additive represented by Chemical Formula 1 may be included in an amount of about 0.01 wt % to about 10 wt %, about 0.1 to about 5 wt %, or about 0.1 to about 1 wt % based on 100 wt % of a total amount of the electrolyte for a rechargeable lithium battery.

The second additive represented by Chemical Formula 2 may be included in an amount of about 0.01 wt % to about 10 wt %, about 0.1 to about 5 wt %, or about 0.1 to about 1 wt % based on 100 wt % of a total amount of the electrolyte for a rechargeable lithium battery

A weight ratio of the first additive represented by Chemical Formula 1 and the second additive represented by Chemical Formula 2 may be about 1:10 to about 10:1, about 1:5 to about 5:1, or about 2:1 to about 1:2.

If (e.g., when) each of the above ranges is satisfied, the effects of the first additive represented by Chemical Formula 1 and/or the second additive represented by Chemical Formula 2 may be suitably optimized or adjusted.

### Additional Additive

The additive may further include other suitable compounds (hereinafter referred to as “additional additives”) in addition to the first additive represented by Chemical Formula 1 and the second additive represented by Chemical Formula 2.

The additional additive may include cyclic carbonates. The cyclic carbonate may be, for example, vinyl ethylene carbonate (VEC), vinylene carbonate (VC), ethylene carbonate (EC), a derivative thereof, or a combination thereof. The derivative of ethylene carbonate may include, for example, fluoroethylene carbonate (FEC), difluoroethylene carbonate, chloroethylene carbonate, dichloroethylene carbonate, bromoethylene carbonate, dibromoethylene carbonate, nitroethylene carbonate, cyanoethylene carbonate, and/or the like.

In one or more embodiments, the additional additive may further include succinonitrile (SN), adiponitrile (AN), 1,3,6-hexane tricyanide (HTCN), propenesultone (PST), propanesultone (PS), lithium tetrafluoroborate (LiBF₄), lithium difluorophosphate (LiPO₂F₂), 2-fluoro biphenyl (2-FBP), or a combination thereof.

The additional additive may be included in an amount of about 0.1 wt % to about 10 wt %, about 0.5 wt % to about 9 wt %, about 1 wt % to about 8 wt %, about 1 wt % to about 7 wt %, about 1 wt % to about 6 wt %, or about 2 wt % to about 5 wt %, based on 100 wt % of a total amount of the electrolyte for a rechargeable lithium battery. If (e.g., when) the amount of the additional additive satisfies the above range, cycle-life characteristics may be improved or enhanced, and the gas generation amount and/or resistance increase rate may be effectively or suitably controlled or adjusted without adversely affecting the rechargeable lithium battery.

### Non-Aqueous Organic Solvent

The non-aqueous (e.g., water-insoluble) organic solvent may serve as a medium that transmits ions taking part in or suitably adjusting the electrochemical reaction of a rechargeable lithium battery.

The non-aqueous (e.g., water-insoluble) organic solvent may be a carbonate-based solvent, an ester-based solvent, an ether-based solvent, a ketone-based solvent, an alcohol-based solvent, an aprotic solvent, or a combination thereof.

The carbonate-based solvent may include dimethyl carbonate (DMC), diethyl carbonate (DEC), dipropyl carbonate (DPC), methylpropyl carbonate (MPC), ethylpropyl carbonate (EPC), ethyl methyl carbonate (EMC), ethylene carbonate (EC), propylene carbonate (PC), butylene carbonate (BC), and/or the like. The ester-based solvent may include methyl acetate, ethyl acetate, n-propyl acetate, dimethyl acetate, methyl propionate, ethyl propionate, decanolide, mevalonolactone, valerolactone, caprolactone, and/or the like. The ether-based solvent may include dibutyl ether, tetraglyme, diglyme, dimethoxyethane, 2-methyltetrahydrofuran, 2,5-dimethyltetrahydrofuran, tetrahydrofuran, and/or the like. The ketone-based solvent may include cyclohexanone and/or the like. The alcohol-based solvent may include ethyl alcohol, isopropyl alcohol, and/or the like. The aprotic solvent may include nitriles, such as R—CN (wherein R may be a C2 to C20 linear, branched, or cyclic hydrocarbon group, a double bond, an aromatic ring, or an ether group), amides, such as dimethylformamide and/or the like, dioxolanes, such as 1,3-dioxolane, 1,4-dioxolane, and/or the like, sulfolanes, and/or the like.

The non-aqueous (e.g., water-insoluble) organic solvent may be used alone or in combination of two or more non-aqueous (e.g., water-insoluble) organic solvents.

In one or more embodiments, if (e.g., when) a carbonate-based solvent is used, cyclic carbonate and chain carbonate may be mixed and used, and cyclic carbonate and chain carbonate may be mixed at a volume ratio of about 1:1 to about 1:9.

For example, the non-aqueous (e.g., water-insoluble) organic solvent may be a mixture of ethylene carbonate (EC), ethyl methyl carbonate (EMC), and diethyl carbonate (DEC). Their volume ratio (e.g., a volume ratio of ethylene carbonate (EC), ethyl methyl carbonate (EMC), and diethyl carbonate (DEC) in a mixture) may not be particularly limited. In one or more embodiments, their volume ratio (e.g., a volume ratio of ethylene carbonate (EC), ethyl methyl carbonate (EMC), and diethyl carbonate (DEC) in a mixture) may be suitably adjusted or modified.

### Lithium Salt

The lithium salt dissolved in an organic solvent may supply lithium ions in a rechargeable lithium battery, enable a basic operation of a rechargeable lithium battery, and/or improve or enhance transportation of the lithium ions between the positive electrode and the negative electrode. Examples of a lithium salt may include one or more selected from among LiPF₆, LiBF₄, LiSbF₆, LiAsF₆, LiClO₄, LiAlO₂, LiAlCl₄, LiPO₂F₂, LiCl, Lil, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (wherein x and y may be integers of 1 to 20), lithium trifluoromethane sulfonate, lithium tetrafluoroethanesulfonate, lithium difluorobis(oxalato)phosphate, (LiDFOB), and lithium bis(oxalato)borate (LiBOB).

For example, LiPF₆ may be used as the lithium salt. For example, the lithium salt may include LiPF₆.

A molar concentration of the lithium salt in the electrolyte may be about 0.8 M to about 2.0 M, for example, about 1.0 M to about 2.0 M.

### Rechargeable Lithium Battery

One or more embodiments of the present disclosure provide a rechargeable lithium battery that may include the electrolyte for a rechargeable lithium battery according to one or more embodiments.

Because a rechargeable lithium battery may include the electrolyte according to one or more embodiments, moisture (e.g., H₂O) in the rechargeable lithium battery may be removed or reduced (e.g., a degree or occurrence of moisture (e.g., H₂O) in the rechargeable lithium battery may be removed or reduced), transition metal elution from the positive electrode active material and/or accompanying side reactions may be suppressed or reduced (e.g., a degree or occurrence of transition metal elution from the positive electrode active material and/or accompanying side reactions may be suppressed or reduced), and/or charging/discharging and/or high-temperature storage characteristics of the rechargeable lithium battery may be improved or enhanced.

Hereinafter, the configuration or arrangement of the rechargeable lithium battery will be described, excluding descriptions that may overlap with the above.

### Positive Electrode Active Material

The positive electrode active material may be a compound (e.g., a lithiated intercalation compound) capable of intercalating and deintercalating lithium. For example, one or more types or kinds of composite oxides of lithium and a metal selected from among cobalt (Co), manganese (Mn), nickel (Ni), and combinations thereof may be used.

The composite oxide may be a lithium transition metal composite oxide, and, for example, may include a lithium nickel-based oxide, a lithium cobalt-based oxide, a lithium manganese-based oxide, a lithium iron phosphate-based compound, a cobalt-free lithium nickel-manganese-based oxide, or a combination thereof.

As an example, a compound represented by any selected from among the following chemical formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}CO_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GeO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above chemical formulas, A may be nickel (Ni), cobalt (Co), manganese (Mn), or a combination thereof; X may be aluminum (Al), nickel (Ni), cobalt (Co), manganese (Mn), chromium (Cr), iron (Fe), magnesium (Mg), strontium (Sr), vanadium (V), a rare earth element, or a combination thereof; D may be oxygen (O), fluorine (F), sulfur (S), phosphorus (P), or a combination thereof; G may be Al, Cr, Mn, Fe, Mg, lanthanum (La), cerium (Ce), Sr, V, or a combination thereof; and L¹ may be Mn, Al, or a combination thereof.

The positive electrode active material may be, for example, a lithium nickel-based oxide represented by Chemical Formula 11, a lithium cobalt-based oxide represented by Chemical Formula 12, a lithium iron phosphate-based compound represented by Chemical Formula 13, a cobalt-free lithium nickel-manganese-based oxide represented by Chemical Formula 14, or a combination thereof.

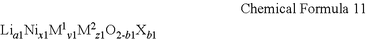

In Chemical Formula 11, 0.9≤a1≤1.8, 0.3≤x1≤1, 0≤y1≤0.7, 0≤z1≤0.7, 0.9≤x1+y1+z1≤1.1, and 0≤b1≤0.1, M¹ and M² may each independently be one or more selected from among aluminum (Al), boron (B), barium (Ba), calcium (Ca), cerium (Ce), cobalt (Co), chromium (Cr), copper (Cu), iron (Fe), magnesium (Mg), manganese (Mn), molybdenum (Mo), niobium (Nb), silicon (Si), tin (Sn), strontium (Sr), titanium (Ti), vanadium (V), tungsten (W), and zirconium (Zr), and X may be one or more selected from among fluorine (F), phosphorus (P), and sulfur (S).

In Chemical Formula 11, 0.6≤x1≤1, 0≤y1≤0.4, and 0≤z1≤0.4, or 0.8≤x1≤1, 0≤y1≤0.2, and 0≤z1≤0.2.

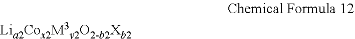

In Chemical Formula 12, 0.9≤a2≤1.8, 0.7≤x2≤1, 0≤y2≤0.3, 0.9≤x2+y2≤1.1, and 0≤b2≤0.1, M³ may be one or more selected from among Al, B, Ba, Ca, Ce, Cr, Cu, Fe, Mg, Mn, Mo, Ni, Se, Si, Sn, Sr, Ti, V, W, Y, Zn, and Zr, and X may be one or more selected from among F, P, and S.

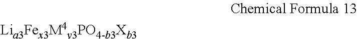

In Chemical Formula 13, 0.9≤a3≤1.8, 0.6≤x3≤1, 0≤y3≤0.4, and 0≤b3≤0.1, M⁴ may be one or more selected from among Al, B, Ba, Ca, Ce, Co, Cr, Cu, Mg, Mn, Mo, Ni, Se, Si, Sn, Sr, Ti, V, W, Y, Zn, and Zr, and X may be one or more selected from among F, P, and S.

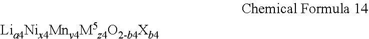

In Chemical Formula 14, 0.9≤a4≤1.8, 0.8≤x4≤1, 0<y4≤0.2, 0≤z4≤0.2, 0.9≤x4+y4+z4≤1.1, and 0≤b4≤0.1, M⁵ may be one or more element selected from among Al, B, Ba, Ca, Ce, Cr, Fe, Mg, Mo, Nb, Si, Sn, Sr, Ti, V, W, and Zr, and X may be one or more selected from among F, P, and S.

For example, a lithium iron phosphate-based compound represented by Chemical Formula 13 may be used as the positive electrode active material.

If (e.g., when) a large amount of moisture (e.g., H₂O) is present in a rechargeable lithium battery, the decomposition of LiPF₆ salt may be accelerated (especially under high temperature conditions), and acidic side reactants represented by hydrogen fluoride (HF) may be generated. If (e.g., when) the HF reacts with the lithium iron phosphate compound represented by Chemical Formula 13, iron (Fe) ions may be eluted. Accordingly, if (e.g., when) the electrolyte according to one or more embodiments capable of removing (or reducing or scavenging) moisture is used, the generation of HF during the decomposition of salt may be suppressed or reduced, and as a result, Fe elution may be reduced.

### Positive Electrode

The positive electrode for a rechargeable lithium battery may include a current collector and a positive electrode active material layer on the current collector. The positive electrode active material layer may include a positive electrode active material and may further include a binder and/or a conductive material (e.g., an electrically conductive material).

For example, the positive electrode may further include an additive that may function as a sacrificial positive electrode.

An amount of the positive electrode active material may be about 90 wt % to about 99.5 wt %, and each amount of the binder and the conductive material (e.g., the electrically conductive material) may be about 0.5 wt % to about 5 wt % based on 100 wt % of the positive electrode active material layer.

The binder may serve to attach or couple the positive electrode active material particles well to each other and also to attach or couple the positive electrode active material well to the current collector. Examples of the binder may include polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and/or the like, but embodiments of the present disclosure are not limited thereto.

The conductive material (e.g., the electrically conductive material) may be used to impart conductivity (e.g., electrical conductivity) to the electrode. Any suitable material that does not cause chemical change (e.g., does not cause an undesirable chemical change in the rechargeable lithium battery) and conducts electrons may be used in the rechargeable lithium battery. Examples of the conductive material (e.g., the electrically conductive material) may include a carbon atom (C)-based material, such as natural graphite, artificial graphite, carbon black, acetylene black, Ketjen black, a carbon fiber, a carbon nanofiber, carbon nanotube, and/or the like; a metal-based material including copper (Cu), nickel (Ni), aluminum (Al), silver (Ag), and/or the like, in a form of a metal powder and/or a metal fiber; a conductive polymer (e.g., an electrically conductive polymer), such as a polyphenylene derivative; or a mixture thereof.

The current collector may include Al, but embodiments of the present disclosure are not limited thereto.

### Negative Electrode Active Material

The negative electrode active material may be a material that reversibly intercalates/deintercalates lithium ions, a lithium metal, a lithium metal alloy, a material capable of doping and dedoping lithium, and/or a transition metal oxide.

The material that reversibly intercalates/deintercalates lithium ions may include a carbon atom (C)-based negative electrode active material, for example, crystalline carbon, amorphous carbon, or a combination thereof. The crystalline carbon may be graphite, such as non-shaped (e.g., irregularly shaped), plate-shaped (e.g., substantially plate-shaped), flake-shaped (e.g., substantially flake-shaped), sphere-shaped (e.g., substantially sphere-shaped), and/or fiber-shaped (e.g., substantially fiber-shaped) natural graphite and/or artificial graphite. The amorphous carbon may be a soft carbon, a hard carbon, a mesophase pitch carbonization product, calcined coke, and/or the like.

The lithium metal alloy may include lithium and a metal selected from among sodium (Na), potassium (K), rubidium (Rb), cesium (Cs), francium (Fr), beryllium (Be), manganese (Mg), calcium (Ca), strontium (Sr), silicon (Si), antimony (Sb), lead (Pb), indium (In), zinc (Zn), barium (Ba), radium (Ra), germanium (Ge), aluminum (Al), and tin (Sn).

The material capable of doping/dedoping lithium may be a silicon atom (Si)-based negative electrode active material and/or a tin atom (Sn)-based negative electrode active material. The Si-based negative electrode active material may include silicon (Si), a silicon-carbon composite, SiOₓ (wherein 0<x≤2), a Si-Q alloy (wherein Q may be selected from among an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include Sn, SnOₖ (wherein 0<k≤2) (e.g., SnO₂), an Sn-based alloy, or a combination thereof.

The silicon-carbon composite may be a composite of silicon and amorphous carbon. According to one or more embodiments, the silicon-carbon composite may be in a form of silicon particles and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may exist dispersed in an amorphous carbon matrix.

The silicon-carbon composite may further include crystalline carbon. For example, the silicon-carbon composite may include a core including crystalline carbon and silicon particles and an amorphous carbon coating layer on a surface of the core.

The Si-based negative electrode active material or the Sn-based negative electrode active material may be used in combination with a carbon-based negative electrode active material.

### Negative Electrode

A negative electrode for a rechargeable lithium battery may include a current collector and a negative electrode active material layer on the current collector. The negative electrode active material layer may include a negative electrode active material and may further include a binder and/or a conductive material (e.g., an electrically conductive material).

For example, the negative electrode active material layer may include about 90 wt % to about 99 wt % of the negative electrode active material, about 0.5 wt % to about 5 wt % of the binder, and about 0.5 wt % to about 5 wt % of the conductive material (e.g., the electrically conductive material).

The binder may serve to attach or couple the negative electrode active material particles well to each other and also to attach or couple the negative electrode active material well to the current collector. The binder may include a non-aqueous (e.g., water-insoluble) binder, an aqueous (e.g., water-soluble) binder, a dry binder, or a combination thereof.

The non-aqueous (e.g., water-insoluble) binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous (e.g., water-soluble) binder may be selected from among a styrene-butadiene rubber, a (meth)acrylated styrene-butadiene rubber, a (meth)acrylonitrile-butadiene rubber, a (meth)acrylic rubber, a butyl rubber, a fluoro rubber, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, and a combination thereof.

If (e.g., when) an aqueous (e.g., water-soluble) binder is used as the negative electrode binder, it may further include a cellulose-based compound capable of imparting or increasing viscosity. The cellulose-based compound may include one or more selected from among carboxylmethyl cellulose, hydroxypropylmethyl cellulose, methyl cellulose, or alkali metal salts thereof. The alkali metal may be Na, K, and/or Li.

The dry binder may be a polymer material capable of being fiberized, and may be, for example, polytetrafluoroethylene, polyvinylidene fluoride, polyvinylidene fluoride-hexafluoropropylene copolymer, polyethylene oxide, or a combination thereof.

The conductive material (e.g., the electrically conductive material) may provide electrode conductivity, and any suitable electrically conductive material may be used as a conductive material unless it causes a chemical change (e.g., an undesirable chemical change in the rechargeable lithium battery). Examples of the conductive material (e.g., the electrically conductive material) may be a carbon-based material, such as natural graphite, artificial graphite, carbon black, acetylene black, Ketjen black, a carbon fiber, a carbon nanofiber, a carbon nanotube, and/or the like; a metal-based material, such as copper, nickel, aluminum silver, and/or the like, in a form of a metal powder and/or a metal fiber; a conductive polymer (e.g., an electrically conductive polymer), such as a polyphenylene derivative; or a mixture thereof.

The negative electrode current collector may include one selected from among a copper foil, a nickel foil, a stainless steel foil, a titanium foil, a nickel foam, a copper foam, a polymer substrate coated with a conductive metal (e.g., an electrically conductive metal), and a combination thereof, but embodiments of the present disclosure are not limited thereto.

### Separator

Depending on the type or kind of the rechargeable lithium battery, a separator may be present or provided between the positive electrode and the negative electrode. The separator may include polyethylene, polypropylene, polyvinylidene fluoride, or a multilayer film of two or more layers thereof, and a mixed multilayer film, such as a polyethylene/polypropylene two-layer separator, polyethylene/polypropylene/polyethylene three-layer separator, polypropylene/polyethylene/polypropylene three-layer separator, and/or the like.

The separator may include a porous substrate and/or a coating layer including an organic material, an inorganic material, or a combination thereof on one surface or both surfaces (e.g., two opposing surfaces) of the porous substrate.

The porous substrate may be a polymer film including any one selected from among a polymer, or a copolymer or mixture of two or more of polyolefin, such as polyethylene or polypropylene, a polyester, such as polyethyleneterephthalate or polybutyleneterephthalate, polyacetal, polyamide, polyimide, polycarbonate, polyether ketone, polyaryl ether ketone, polyether imide, polyamideimide, polybenzimidazole, polyether sulfone, polyphenyleneoxide, a cyclic olefin copolymer, polyphenylenesulfide, polyethylenenaphthalate, a glass fiber, and polytetrafluoroethylene (e.g., Teflon™).

The organic material may include a polyvinylidene fluoride-based polymer and/or a (meth)acrylic polymer.

The inorganic material may include inorganic particles selected from among Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but embodiments of the present disclosure are not limited thereto.

The organic material and the inorganic material may be mixed in one coating layer, or a coating layer including an organic material and a coating layer including an inorganic material may be stacked.

### Rechargeable Lithium Battery

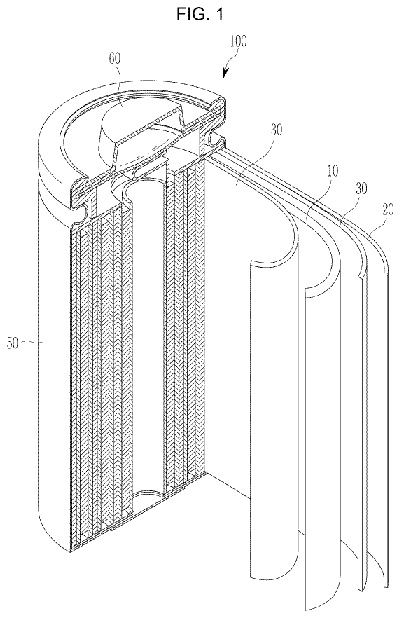

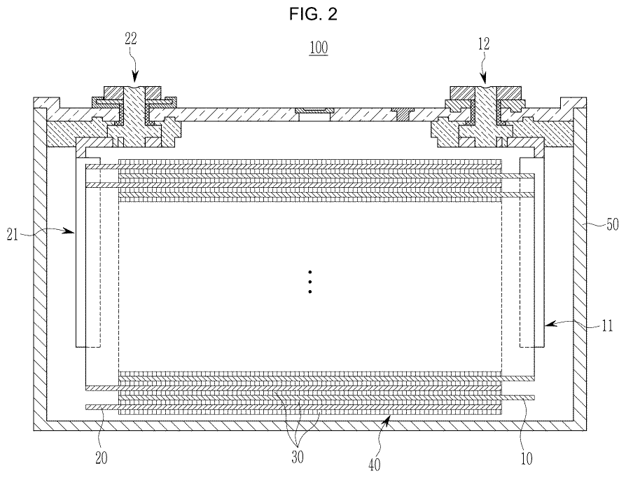

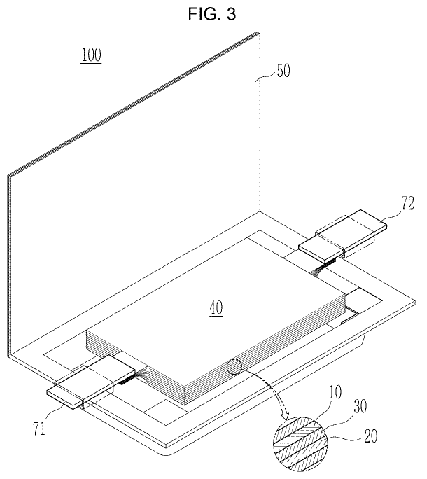

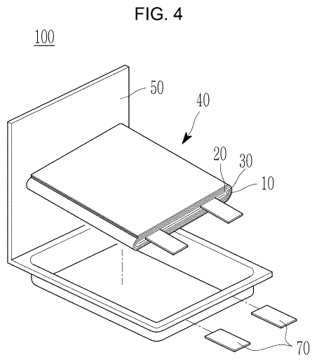

The rechargeable lithium battery may be classified into cylindrical, prismatic, pouch, or coin-type or -kind batteries, and/or the like depending on their shape. FIGS. 1-4 each is a schematic view illustrating a rechargeable lithium battery according to one or more embodiments. FIG. 1 is a schematic view illustrating a circular battery, FIG. 2 is a schematic view illustrating a prismatic battery, and FIGS. 3-4 each is a schematic view illustrating pouch-type or -kind batteries. Referring to FIGS. 1-4, the rechargeable lithium battery 100 may include an electrode assembly 40 including a separator 30 between a positive electrode 10 and a negative electrode 20, and a case 50 in which the electrode assembly 40 may be housed. The positive electrode 10, the negative electrode 20, and the separator 30 may be impregnated with an electrolyte. The rechargeable lithium battery 100 may include a sealing member 60 that seals the case 50 as shown in FIG. 1. In one or more embodiments, in FIG. 2, the rechargeable lithium battery 100 may include a positive lead tab 11, a positive terminal 12, a negative lead tab 21, and a negative terminal 22. As shown in FIGS. 3-4, the rechargeable lithium battery 100 may include an electrode tab 70, for example, a positive electrode tab 71 and a negative electrode tab 72 serving as an electrical path to include the current formed or provided in the electrode assembly 40 to the outside.

The rechargeable lithium battery according to one or more embodiments may be applied to automobiles, mobile phones, and/or one or more suitable types or kinds of electrical devices, but embodiments of the present disclosure are not limited thereto.

Hereinafter, examples of the present disclosure and comparative examples are described. These examples, however, are not in any sense to be interpreted as limiting the scope of the present disclosure.

### Example 1

### (1) Preparation of Electrolyte

A LiPF₆ lithium salt was mixed at a concentration of 1.5 M in an organic solvent in which ethylene carbonate (EC), ethyl methyl carbonate (EMC), and diethyl carbonate (DEC) were mixed at a volume ratio of 2:4:4, and 0.5 wt % of a first additive represented by Chemical Formula 1-1 and 0.5 wt % of a second additive represented by Chemical Formula 2-1 were added thereto to prepare an electrolyte.

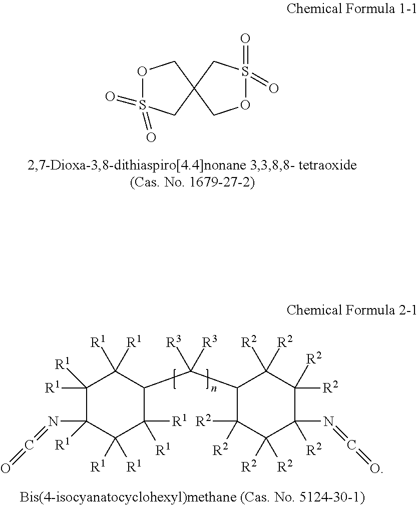

In Chemical Formula 2-1, R¹ to R² are all hydrogen atoms, and n may be 1.

In one or more embodiments, in the electrolyte composition, “wt %” was based on a total amount of the electrolyte (e.g., a lithium salt+non-aqueous (e.g., water-insoluble) organic solvent+a first additive+a second additive). Hereinafter, substantially the same as above was applied.

### (2) Manufacturing of Positive Electrode

A positive electrode active material layer slurry was prepared by mixing 97.7 wt % of LiFePO₄ as a positive electrode active material, 1.3 wt % of a polyvinylidene fluoride binder, and 1.0 wt % of a carbon nanotube conductive material, and was coated on an aluminum foil current collector, dried and pressed to manufacture a positive electrode.

### (3) Manufacturing of Negative Electrode

A negative electrode active material layer slurry was prepared by mixing 97.5 wt % of a graphite negative electrode active material, 1.5 wt % of carboxymethyl cellulose, and 1 wt % of a styrene butadiene rubber in a water solvent. A negative electrode was manufactured by coating the negative electrode active material layer slurry on a copper foil current collector, drying, and pressing.

### (4) Manufacturing of Rechargeable Lithium Battery Cell

The resultant positive electrode and the resultant negative electrode were assembled with a 25 μm-thick polyethylene separation membrane to manufacture an electrode assembly, the electrode assembly was housed in a prismatic case, and the electrolyte was implanted thereinto to manufacture a rechargeable lithium battery cell.

### Example 2

An electrolyte and a rechargeable lithium battery cell of Example 2 were manufactured in substantially the same manner as in Example 1 except that 0.5 wt % of the first additive represented by Chemical Formula 1-1 and 0.1 wt % of the second additive represented by Chemical Formula 2-1 were used.

### Example 3

An electrolyte and a rechargeable lithium battery cell of Example 3 were manufactured in substantially the same manner as in Example 1 except that 0.5 wt % of the first additive represented by Chemical Formula 1-1 and 0.3 wt % of the second additive represented by Chemical Formula 2-1 were used.

### Example 4

An electrolyte and a rechargeable lithium battery cell of Example 4 were manufactured in substantially the same manner as in Example 1 except that 0.1 wt % of the first additive represented by Chemical Formula 1-1 and 0.5 wt % of the second additive represented by Chemical Formula 2-1 were used.

### Example 5

An electrolyte and a rechargeable lithium battery cell of Example 5 were manufactured in substantially the same manner as in Example 1 except that 0.3 wt % of the first additive represented by Chemical Formula 1-1 and 0.5 wt % of the second additive represented by Chemical Formula 2-1 were used.

### Example 6

Substantially the same electrolyte as used in Example 1 was used. A rechargeable lithium battery cell of Example 6 was manufactured in substantially the same manner as in Example 1 except that LiNi_{0.9}Co_{0.08}Al_{0.02}O₂ was used instead of LiFePO₄ as a positive electrode active material.

### Example 7

Substantially the same electrolyte as used in Example 1 was used. A rechargeable lithium battery cell of Example 7 was manufactured in substantially the same manner as in Example 1 except that LiNi_{0.8}Co_{0.1}Mn_{0.1}O₂ was used instead of LiFePO₄ as a positive electrode active material.

### Comparative Example 1

An electrolyte and a rechargeable lithium battery cell of Comparative Example 1 were manufactured in substantially the same manner as in Example 1 except that the first additive represented by Chemical Formula 1-1 and the second additive represented by Chemical Formula 2-1 were not used.

### Comparative Example 2

An electrolyte and a rechargeable lithium battery cell of Comparative Example 2 were manufactured in substantially the same manner as in Example 1 except that 0.5 wt % of the first additive represented by Chemical Formula 1-1 alone was used.

### Comparative Example 3

An electrolyte and a rechargeable lithium battery cell of Comparative Example 3 were manufactured in substantially the same manner as in Example 1 except that 0.5 wt % of the second additive represented by Chemical Formula 2-1 alone was used.

For reference, the positive electrode active materials and the additives of Examples 1 to 6 and Comparative Examples 1 to 3 are shown in Table 1.

TABLE 1

| | | Amount of additive (wt %) | |
|---|---|---|---|
| | Type/kind of | First additive | Second additive |
| | positive electrode | (Chemical | (Chemical |
| | active material | Formula 1-1) | Formula 2) |
| Example 1 | LiFePO₄ | 0.5 | 0.5 |
| Example 2 | LiFePO₄ | 0.5 | 0.1 |
| Example 3 | LiFePO₄ | 0.5 | 0.3 |
| Example 4 | LiFePO₄ | 0.1 | 0.5 |
| Example 5 | LiFePO₄ | 0.3 | 0.5 |
| Example 6 | LiNi_{0.9}Co_{0.08}Al_{0.02}O₂ | 0.5 | 0.5 |
| Example 7 | LiNi_{0.8}Co_{0.1}Mn_{0.1}O₂ | 0.5 | 0.5 |
| Comparative | LiFePO₄ | — | — |
| Example 1 | | | |
| Comparative | LiFePO₄ | 0.5 | — |
| Example 2 | | | |
| Comparative | LiFePO₄ | — | 0.5 |
| Example 3 | | | |

### Evaluation Example 1: Cycle-Life Characteristics

### (1) Room-Temperature Cycle-Life Characteristics

The rechargeable lithium battery cells according to Examples 1 to 7 and Comparative Examples 1 to 3 were 400 cycles charged at 0.5 C (CC/CV, 3.65 V, cut-off at 0.025 C)/discharged at 1.0 C (CC, cut-off at 2.5 V) at 25° C. to calculate a room-temperature capacity retention ratio (CRR) according to Equation 1.

### (2) High-Temperature Cycle-Life Characteristics

The rechargeable lithium battery cells according to Examples 1 to 7 and Comparative Examples 1 to 3 were 400 cycles charged at 0.5 C (CC/CV, 3.65 V, cut-off at 0.025 C)/discharged at 1.0 C (CC, cut-off at 2.5 V) at 45° C. to calculate a room-temperature capacity retention ratio (CRR) according to Equation 1.

$$Capacity retention rate [ \% ] = ( Discharge capacity after 200 cycles / Discharge capacity after 1 st cycle ) ⋆ 100 \qquad Equation 1$$

TABLE 2

| | Cycle-life characteristics | |
|---|---|---|
| | (capacity retention rate) [%] | |
| | Room temperature | High temperature |
| | @ 25° C., 400 Cyc. | @ 45° C., 400 Cyc. |
| Example 1 | 97.28 | 89.54 |
| Example 2 | 96.59 | 88.45 |
| Example 3 | 97.14 | 88.98 |
| Example 4 | 96.42 | 88.74 |
| Example 5 | 97.01 | 89.18 |
| Example 6 | 94.18 | 87.21 |
| Example 7 | 94.5 | 87.34 |
| Comparative Example 1 | 93.47 | 84.26 |
| Comparative Example 2 | 94.92 | 86.48 |
| Comparative Example 3 | 94.54 | 85.79 |

### Evaluation Example 2: High-Temperature Storage Characteristics

### (1) DC-IR Increase Rate

The rechargeable lithium battery cells according to Examples 1 to 7 and Comparative Examples 1 to 3 were measured with respect to initial DC internal resistance (DCIR) by ΔV/ΔI (voltage change/current change) and then, DC resistance after making a maximum energy state of each of the cells into a full-charge state (SOC 100%) and then, storing the cells in this state at a high temperature (60° C.) for 60 days to calculate a DC-IR increase rate (%) according to Equation 2, and the results are shown in Table 3:

$$DC - IR increase rate [ \% ] = ( DC - IR after 60 days of high - temperature storage / initial DC - IR ) ⋆ 100 \qquad Equation 2$$

### (2) Cycle-Life (Capacity Retention Rate)

The rechargeable lithium battery cells of Examples 1 to 7 and Comparative Examples 1 to 3 were one cycle charged and discharged immediately after manufacturing them and then, measured with respect to discharge capacity (initial discharge capacity). Subsequently, after making an internal maximum energy state of the battery cells into a full-charge state (SOC 100%), the cells were stored at a high temperature (60° C.) for 60 days and then, 1 cycle charged and discharged to measure discharge capacity (discharge capacity after stored at a high temperature), which was used to calculate capacity retention (%) according to Equation 3, and the results are shown in Table 3:

$$Capacity retention rate [ \% ] = ( discharge capacity after high temperature storage / initial discharge capacity ) ⋆ 100 \qquad Equation 3$$

### (3) Amount of Gas Generated

For the rechargeable lithium battery cells according to Examples 1 to 7 and Comparative Examples 1 to 3, the amount of gas generated was measured immediately after manufacturing, and the results are shown in Table 3:

TABLE 3

| | High-temperature storage characteristics | | |
|---|---|---|---|
| | DC-IR increase | capacity | Amount of gas |
| | rate [%] | retention [%] | generated [ml] |
| Example 1 | 121.9 | 96.2 | 11.48 |
| Example 2 | 123 | 94.1 | 12.26 |
| Example 3 | 122.4 | 95.3 | 11.98 |
| Example 4 | 123.3 | 94.5 | 12.34 |
| Example 5 | 122.3 | 95.2 | 12.05 |
| Example 6 | 127.3 | 93.1 | 12.95 |
| Example 7 | 126.9 | 92.6 | 12.54 |
| Comparative Example 1 | 138.5 | 89.5 | 14.9 |
| Comparative Example 2 | 127.7 | 92.7 | 13.51 |
| Comparative Example 3 | 127.3 | 93.0 | 13.66 |

### Summary

Referring to Tables 2 and 3, in the case of using LiFePO₄ as a positive electrode active material, the rechargeable lithium battery cells using the electrolytes according to Examples 1 to 5, compared with the cells according to Comparative Examples 1 to 3, exhibited improved room temperature and high temperature cycle-life characteristics (increased capacity retention) and in addition, improved storage characteristics at a high temperature (decreased DC-IR, increased capacity retention, and a reduced amount of gas generated).

In one or more embodiments, referring to Examples 1 to 5, the effects may be controlled by adjusting a weight ratio of the first additive represented by Chemical Formula 1 and the second additive represented by Chemical Formula 2.

On other hand, the rechargeable lithium battery cells of Examples 6 and 7, in which the positive electrode active material was changed, while using substantially the same electrolyte as in Example 1, exhibited improved effects, compared with the cell of Comparative Example 1, but deteriorated effects, compared with Examples 1 to 5. Accordingly, the electrolyte for a rechargeable lithium battery according to one or more embodiments, which was represented by Example 1, was confirmed to exhibit optimal effects when combined with LiFePO₄ as a positive electrode active material, even though combined with any suitable positive electrode active material.

While the subject matter of the present disclosure has been described in connection with what is presently considered to be practical embodiments, it is to be understood that embodiments of the present disclosure are not limited to the disclosed embodiments, but, on the contrary, are intended to cover one or more suitable modifications and equivalent arrangements included within the spirit and scope of the appended claims and equivalents thereof. It therefore will be understood that one or more embodiments described above are just illustrative but not limitative in all aspects.

### DESCRIPTION OF SYMBOLS

| | |
|---|---|
| 100: rechargeable lithium battery | 10: positive electrode |
| 11: positive electrode lead tab | 12: positive terminal |
| 20: negative electrode | 21: negative electrode lead |
| 22: negative terminal | 30: separator |
| 40: electrode assembly | 50: case |
| 60: sealing member | 70: electrode tab |
| 71: positive electrode tab | 72: negative electrode tab |

What is claimed is:

1. An electrolyte for a rechargeable lithium battery, comprising:
a non-aqueous organic solvent;
a lithium salt; and
an additive,
wherein the additive comprises:
a first additive represented by Chemical Formula 1; and
a second additive represented by Chemical Formula 2: 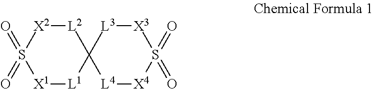
wherein, in Chemical Formula 1,
X¹ to X⁴ are each independently a single bond, an oxygen atom (O), or a sulfur atom (S); and
L¹ to L⁴ are each independently a single bond, a carbonyl group, a sulfinyl group, or a substituted or unsubstituted C1 to C10 alkylene group: 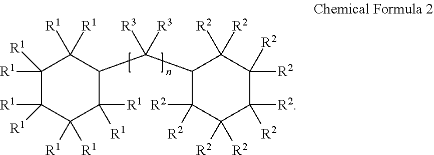
wherein, in Chemical Formula 2,
R¹ is the same or different and is each independently a hydrogen atom, a halogen atom, an alkyl group having 1 to 10 carbon atoms, or an isocyanate group; provided that at least one selected from among R¹s is an isocyanate group;
R² is the same or different and is each independently a hydrogen atom, a halogen atom, an alkyl group having 1 to 10 carbon atoms, or an isocyanate group; provided that at least one selected from among R²s is an isocyanate group;
R³ is the same or different and is each independently a hydrogen atom or a cyclohexyl isocyanate moiety; and
n is an integer of 1 to 10.

2. The electrolyte as claimed in claim 1, wherein:
L¹ to L⁴ are each independently a substituted or unsubstituted C1 to C5 alkylene group.

3. The electrolyte as claimed in claim 1, wherein:
one selected from among X¹ and X² is an oxygen atom (O), and one selected from among X³ and X⁴ is an oxygen atom (O).

4. The electrolyte as claimed in claim 1, wherein:
Chemical Formula 1 is represented by Chemical Formula 1-1 or 1-2:

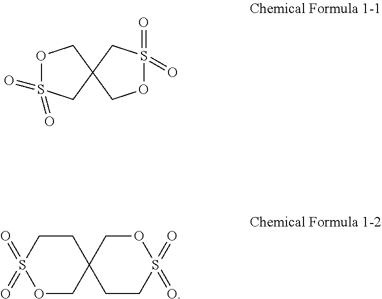 [SMILES: O=S1(=O)CC2(CO1)COS(=O)(=O)C2 ; O=S1(=O)CCC2(CCS(=O)(=O)OC2)CO1]

5. The electrolyte as claimed in claim 1, wherein:
Chemical Formula 2 is represented by Chemical Formula 2-1: 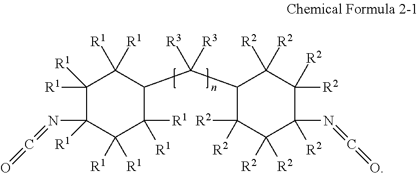
wherein, in Chemical Formula 2-1,
R¹ is the same or different and is each independently a hydrogen atom, a halogen atom, or an alkyl group having 1 to 10 carbon atoms; and
R² is the same or different and is each independently a hydrogen atom, a halogen atom, or an alkyl group having 1 to 10 carbon atoms.

6. The electrolyte as claimed in claim 1, wherein:
the first additive represented by Chemical Formula 1 is included in an amount of about 0.01 wt % to about 10 wt % based on 100 wt % of a total amount of the electrolyte for a rechargeable lithium battery.

7. The electrolyte as claimed in claim 1, wherein:
the second additive represented by Chemical Formula 2 is included in an amount of about 0.01 wt % to about 10 wt % based on 100 wt % of a total amount of the electrolyte for a rechargeable lithium battery.

8. The electrolyte as claimed in claim 1, wherein:
a weight ratio of the first additive represented by Chemical Formula 1 and the second additive represented by Chemical Formula 2 is about 1:10 to about 10:1.

9. The electrolyte as claimed in claim 1, wherein:
the non-aqueous organic solvent comprises ethylene carbonate (EC), ethyl methyl carbonate (EMC), and diethyl carbonate (DEC).

10. The electrolyte as claimed in claim 1, wherein:
the lithium salt comprises LiPF₆.

11. A rechargeable lithium battery, comprising:
a positive electrode comprising a positive electrode active material;
a negative electrode comprising a negative electrode active material, and
the electrolyte as claimed in claim 1.

12. The rechargeable lithium battery as claimed in claim 11, wherein:
the positive electrode active material comprises a lithium nickel-based oxide, a lithium cobalt-based oxide, a lithium manganese-based oxide, a lithium iron phosphate-based compound, a cobalt-free lithium nickel-manganese-based oxide, or a combination thereof.

13. The rechargeable lithium battery as claimed in claim 12, wherein:
the positive electrode active material is a lithium iron phosphate-based compound represented by Chemical Formula 13: 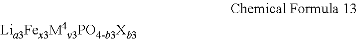
wherein, in Chemical Formula 13,
0.9≤a3≤1.8, 0.6≤x3≤1, 0≤y3≤0.4, and 0≤b3≤0.1,
M⁴ is one or more selected from among Al, B, Ba, Ca, Ce, Co, Cr, Cu, Mg, Mn, Mo, Ni, Se, Si, Sn, Sr, Ti, V, W, Y, Zn, and Zr, and
X is one or more selected from among F, P, and S.

14. The rechargeable lithium battery as claimed in claim 11, wherein:
the negative electrode active material comprises a Si-based negative electrode active material, a carbon-based negative electrode active material, or a combination thereof.

15. The rechargeable lithium battery as claimed in claim 14, wherein:
the negative electrode active material is a carbon-based negative electrode active material.
